(19) United States
(12) Patent Application Publication
(10) Pub. No.: US 2006/0259366 A1
(43) Pub. Date: Nov. 16, 2006

(54) Method for ordering consigning shipping and delivering goods

(76) Inventors: Barbara Niven, Matraville (AU); James John Niven, Matraville (AU); Joseph Niven, Matraville (AU)

Correspondence Address: STEPTOE & JOHNSON LLP, 1330 CONNECTICUT AVENUE, N.W., WASHINGTON, DC, 20036, US

(21) Appl. No.: 10/540,538

(22) PCT Filed: Apr. 16, 2004
(86) PCT No.: PCT/AU04/00507

§ 371 Date: Jul. 7, 2006

(30) Foreign Application Priority Data
Apr. 16, 2003 (AU) 2003100275

(51) Int. Cl. G06Q 30/00

(52) U.S. Cl. 705/26

(57) ABSTRACT

A method for ordering, consigning, shipping and delivering of goods between a retailer, manufacturer and carrier, which reduces the requirement for warehousing and wherein the ultimate address information for the goods is provided by the retailer while the goods are in transit from the manufacturer.

The present invention relates to a method for ordering, consigning, shipping and delivering goods and in particular to a method where the final address details of the goods may be provided up until the last possible moment before being delivered to a retailer of the goods.

### BACKGROUND OF THE INVENTION

In a typical goods supply chain, when a retailer is interested in ordering new stock for whatever goods they provide, they place an order with a wholesaler in their general vicinity. The wholesaler typically would have these goods stored for distribution in warehouses within easy transportation of the retailer.

The wholesaler themselves may source the goods directly from the manufacturer and/or other wholesalers, and quite often nowadays goods are manufactured in countries outside their final destination of sale. Normally the transportation of goods is handled by a shipping company that transports the goods from destination to destination.

Once a wholesaler receives a delivery of goods, usually in the form of a container load, from a prospective manufacturer, the goods are unpacked, catalogued, repacked and stored in the wholesaler's warehouse where they await distribution upon an order from a retailer.

When the order comes in from a retailer, the goods are once again repacked according to the order, shipped to the retailer where they are once again unpacked and catalogued for use by the retailer.

As a result of the numerous steps in a typical supply chain, goods being distributed from a manufacturer to the ultimate customer spend a significant amount of time in wholesale warehouses, which costs a considerable amount of money. This cost simply adds to the cost of the goods paid for by the ultimate customer.

Accordingly, the present invention seeks to provide a method that reduces the cost of warehousing within the typical goods supply chain. Furthermore, the present invention seeks to provide a method of ordering, consigning, shipping, and delivering goods using a direct interface made possible through communication via the Internet.

### SUMMARY OF INVENTION

According to one aspect the present invention provides a method for the ordering, consigning, shipping and delivering of goods between a retailer, manufacturer and carrier, which reduces the requirement for warehousing and wherein the ultimate address information for the goods is provided by the retailer whilst the goods are in transit from the manufacturer.

According to another aspect the present invention provides a method for the ordering, consigning, shipping and delivering of goods between a retailer, manufacturer and carrier including the steps of:
a) the retailer placing an order for a quantity of goods from the manufacturer via an internet site, wherein the order includes the following information:
   i) the quantity of goods required, and
   ii) the name of the port of delivery;
b) the manufacturer receiving information as to the quantity of the goods required via the internet site and producing same, whereupon the manufacturer indicates the goods are ready for shipping to the carrier via the internet site;
c) the goods being labelled with a consignment note sticker which has been allocated by the internet site, whereby the consignment note sticker identifies the goods in transit to the corresponding order by way of an identifying system, wherein the identifying system does not include the address information as to the destination of the goods;
d) the goods being shipped by the carrier company to the port of delivery;
e) the retailer being advised the goods have arrived at the port of delivery via the internet site;
f) the retailer providing the address information as to the destination of the goods to the carrier via the internet site, whereby the address information may be provided at any time from placing the order up until the goods are ready to be transported from the port of delivery to the destination; and
g) the carrier receiving the address information via the internet site correlating to the consignment sticker whereupon the carrier transports the goods to the destination.

The consignment note sticker may include an identifying system chosen from bar codes, product codes, alphanumeric codes, product description, consignment numbers and/or microchip technology.

Preferably, the address information as to the destination of the goods includes more than one address with varying quantities of the goods being delivered to the various addresses. More preferably, the retailer uses stock information current up until the time the goods arrive at the port of delivery in order to provide the most appropriate address information as to the destination of the goods.

Preferably, the internet site is user specific wherein the retailer may access information on the order applicable to the retailer, the carrier may access information on the order applicable to the carrier and the manufacturer may access information on the order applicable to the manufacturer.

### BRIEF DESCRIPTION OF THE FIGURES

The present invention will become better understood from the following detailed description of a preferred but non-limiting embodiment thereof, described in connection with the accompanying FIGURE, where in:

FIG. 1 is a schematic diagram outlining a method for the ordering, consigning, shipping and delivering of goods in accordance with one aspect of the present invention.

### DETAILED DESCRIPTION OF THE INVENTION

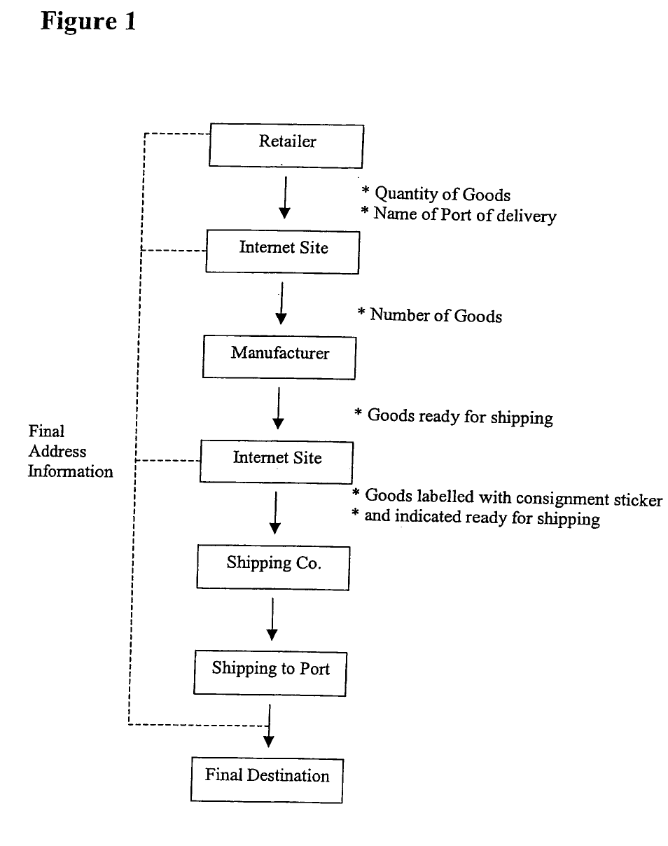

Referring to the flow diagram depicted in FIG. 1, a retailer wishing to order more goods may do so through a web site interface using the Internet. The retailer may have their own secure logon and interface which then asks only the information required to be entered in order to start the goods supply chain, that is, the quantity of a particular good and name of the port of delivery.

The port of delivery would be simply the name of the main shipping/transportation port, which would be central to the geographic location the retailer would ultimately like the goods to be delivered. The retailer does not have to enter the final destination address information, as this information is likely to change over the course from when the goods are manufactured and transported to when they arrive at the port of delivery. For example, the retailer may wish to allocate goods to various retail outlets depending on each of the outlets stock requirements.

Once the quantity of goods required and the port of delivery information has been provided by the retailer, the manufacturer receives the information concerning the number of goods required via their own secure logon and interface through the internet web site. The manufacturer then proceeds to prepare the numbers of goods required and indicates via the web site when they are ready for shipping.

At this stage, the goods are provided with a consignment sticker, which identifies the goods in the course of transit. But the consignment sticker does not depict the ultimate address information because the retailer may not have provided this information as yet.

The shipping company then ships the goods to the port of delivery. It is up until this point that the retailer may provide the ultimate address information for goods in question. By this time, demand for the stock may have shifted from outlet to outlet such that the retailer may make a more appropriate allocation of the goods than they would have made if they were required to provide the ultimate address information with the initial order.

Furthermore, this method reduces the requirement for warehousing the goods, as they goods may move straight to the point of sale from the manufacturer without the need to employ a wholesaling step.

Finally, it can be understood that the inventive concept in any of its aspects can be incorporated in many different constructions so that generality of the preceding description is not superseded by the particularity of the attached drawings. Various alterations, modifications and/or additions may be incorporated into the various constructions and arrangements of parts without departing from the spirit or ambit of the present invention.

1. Method for the ordering, consigning, shipping and delivering of goods between a retailer, manufacturer and carrier including the steps of:
a) the retailer placing an order for a quantity of goods from the manufacturer via an internet site, wherein the order includes the following information:
i) the quantity of goods required, and
ii) the name of the port of delivery;
b) the manufacturer receiving information as to the quantity of the goods required via the internet site and producing same, whereupon the manufacturer indicates the goods are ready for shipping to the carrier via the internet site;
c) the goods being labelled with a consignment note sticker which has been allocated by the internet site, whereby the consignment note sticker identifies the goods in transit to the corresponding order by way of an identifying system, wherein the identifying system does not include the address information as to the destination of the goods;
d) the goods being shipped by the carrier company to the port of delivery;
e) the retailer being advised the goods have arrived at the port of delivery via the internet site;
f) the retailer providing the address information as to the destination of the goods to the carrier via the internet site, whereby the address information may be provided at any time from placing the order up until the goods are ready to be transported from the port of delivery to the destination; and
g) the carrier receiving the address information via the internet site correlating to the consignment sticker whereupon the carrier transports the goods to the destination.

2. The method according to claim 1 wherein the consignment note sticker includes an identifying system chosen from bar codes, product codes, alpha numeric codes, product description, consignment numbers and/or microchip technology.

3. The method according to claim 1 wherein the address information as to the destination of the goods includes more than one address with varying quantities of the goods being delivered to the various addresses.

4. The method according to claim 1 wherein the retailer uses stock information current up until the time the goods arrive at the port of delivery in order to provide the most appropriate address information as to the destination of the goods.

5. The method according to claim 1 wherein the internet site is user specific wherein the retailer may access information on the order applicable to the retailer, the carrier may access information on the order applicable to the carrier and the manufacturer may access information on the order applicable to the manufacturer.

6. The method according to claim 2 wherein the address information as to the destination of the goods includes more than one address with varying quantities of the goods being delivered to the various addresses.

7. The method according to claim 2 wherein the retailer uses stock information current up until the time the goods arrive at the port of delivery in order to provide the most appropriate address information as to the destination of the goods.

8. The method according to claim 3 wherein the retailer uses stock information current up until the time the goods arrive at the port of delivery in order to provide the most appropriate address information as to the destination of the goods.

9. The method according to claim 6 wherein the retailer uses stock information current up until the time the goods arrive at the port of delivery in order to provide the most appropriate address information as to the destination of the goods.

10. The method according to claim 2 wherein the internet site is user specific wherein the retailer may access information on the order applicable to the retailer, the carrier may access information on the order applicable to the carrier and the manufacturer may access information on the order applicable to the manufacturer.

11. The method according to claim 3 wherein the internet site is user specific wherein the retailer may access information on the order applicable to the retailer, the carrier may access information on the order applicable to the carrier and the manufacturer may access information on the order applicable to the manufacturer.

12. The method according to claim 4 wherein the internet site is user specific wherein the retailer may access information on the order applicable to the retailer, the carrier may access information on the order applicable to the carrier and the manufacturer may access information on the order applicable to the manufacturer.

13. The method according to claim 6 wherein the internet site is user specific wherein the retailer may access information on the order applicable to the retailer, the carrier may access information on the order applicable to the carrier and the manufacturer may access information on the order applicable to the manufacturer.

14. The method according to claim 7 wherein the internet site is user specific wherein the retailer may access information on the order applicable to the retailer, the carrier may access information on the order applicable to the carrier and the manufacturer may access information on the order applicable to the manufacturer.

15. The method according to claim 8 wherein the internet site is user specific wherein the retailer may access information on the order applicable to the retailer, the carrier may access information on the order applicable to the carrier and the manufacturer may access information on the order applicable to the manufacturer.

16. The method according to claim 9 wherein the internet site is user specific wherein the retailer may access information on the order applicable to the retailer, the carrier may access information on the order applicable to the carrier and the manufacturer may access information on the order applicable to the manufacturer.
